(19) United States
(12) Patent Application Publication
(10) Pub. No.: US 2008/0115953 A1
(43) Pub. Date: May 22, 2008

(54) Rock Drilling Device

(76) Inventors: Kurt Andersson, Tyreso (SE); Jorgen Rodert, Saltsjo-Boo (SE)

Correspondence Address: Mark P Stone, 25 Third Street, 4 Floor, Stamford, CT, 06905, US

(21) Appl. No.: 11/663,085

(22) PCT Filed: Sep. 28, 2005
(86) PCT No.: PCT/SE05/01424

§ 371 Date: Mar. 15, 2007

(30) Foreign Application Priority Data
Oct. 7, 2004 (SE) 0402421-2

(51) Int. Cl. B25D 17/26

(52) U.S. Cl. 173/171

(57) ABSTRACT

Rock drilling device including a rock drilling machine (1) which is movable forwards and backwards along a feed beam, (2 wherein the rock drilling machine (1) is pivotal around an axis (3) which is arranged along the rock drilling machine (1), and a channel (4) for supply of lubricant to points of lubrication in the rock drilling machine (1), wherein the channel (4) includes a sleeve (5) which is provided with a number of generally radial holes (6) that are distributed along the circumference of the sleeve (5), that a groove (7) is arranged around the sleeve (5) in connection with the radial holes (6), and that the radial holes (6) are dimensioned such that a part of the lubricant leaves the channel (4) through the radial holes (6).

The present invention relates to a rock drilling device provided with a rock drilling machine which is movable forwards and backwards along a feed beam, wherein the rock drilling machine is pivotal around an axis which is arranged along the rock drilling machine. In particular the invention concerns such a device which is arranged to ensure good lubrication of vital parts independent of the pivoting of the rock drilling machine around the longitudinal axis.

According to previously known art, it is common to provide points of lubrication with lubricant by leading oil-rich air through a channel to the point of lubrication. This method has that drawback that the lubrication will be dependent on the pivot angle of the rock drilling machine with respect to its longitudinal axis, because the lubricant tends to accumulate at the bottom of the channel instead of appearing as an oil mist.

The present invention, as defined in the following patent claim, aims at providing a rock drilling device where the lubrication is essentially enhanced independent of the pivotal position of the rock drilling machine.

An embodiment of the invention is described below with reference to the annexed drawing, wherein

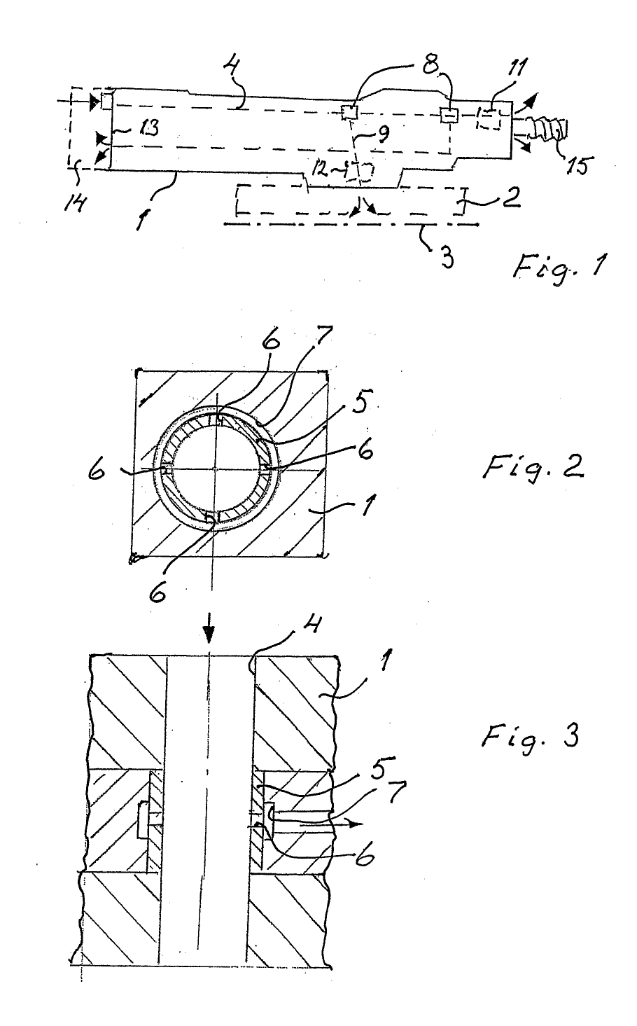

FIG. 1 shows a diagrammatical view of the rock drilling device.

FIG. 2 shows a section through a part of the device according to FIG. 1.

FIG. 3 shows a section through the part according to FIG. 2.

The rock drilling device shown on the drawing includes a rock drilling machine 1, which is movable forwards and backwards along a feed beam 2. The rock drilling machine 1 and the feed beam 2 are pivotal around an axis 3 which extends along the feed beam 2. A channel 4 is leading through the rock drilling machine 2 for supply of lubricant to different points of lubrication. This is achieved by means of oil-rich air. In the channel 4 there are a number of distributors 8 for distributing the lubrication air between the channel 4 and a further channel 9 which leads to the point of lubrication. In the shown example lubrication takes place of a front guide 11, a follower device 12 for rotation of a drilling tool 15 and a parting plane 13 between the main body of the rock drilling machine 1 and a rear portion 14. The construction of the distributors 8 is shown in more detail in FIGS. 2 and 3.

The distributor 8 includes a sleeve 5 which is positioned inside the channel 4, said sleeve being provided with a number of generally radial holes 6, distributed along the circumference of the sleeve 5. Around the sleeve 5 is arranged a groove 7 which connects the radial holes 6. The holes 6 are dimensioned in such a way that a suitable portion of the lubricant leaves the channel 4 through the radial holes 6 to the channel 9 and a point of lubrication connected thereto.

1. Rock drilling device including a rock drilling machine which is movable forwards and backwards along a feed beam, wherein the rock drilling machine is pivotal around an axis which is arranged along the rock drilling machine, and a channel for supply of lubricant to points of lubrication in the rock drilling machine, wherein the channel includes a sleeve which is provided with a number of generally radial holes that are distributed along the circumference of the sleeve, a groove is arranged around the sleeve in connection with the radial holes, and the radial holes are dimensioned such that a part of the lubricant leaves the channel through the radial holes.
